(19) United States
(12) Patent Application Publication
(10) Pub. No.: US 2026/0075523 A1
(43) Pub. Date: Mar. 12, 2026

(54) LOW-POWER WAKE-UP SIGNAL (LP-WUS) FOR LOW-LATENCY TRAFFIC

(71) Applicant: QUALCOMM Incorporated, San Diego, CA (US)

(72) Inventors: Weimin DUAN, San Diego, CA (US); Huilin XU, Temecula, CA (US); Kangqi LIU, San Diego, CA (US)

(21) Appl. No.: 18/830,409

(22) Filed: Sep. 10, 2024

(51) Int. Cl. H04W 52/02; H04L 5/00; H04W 76/28

(52) U.S. Cl. CPC H04W 52/0229; H04L 5/0053; H04W 76/28

(57) ABSTRACT

A method for wireless communication at a user equipment (UE) includes monitoring for a low-power wake-up signal (LP-WUS) during one or more LP-WUS periods of a group of LP-WUS periods. The one or more LP-WUS periods may be configured in accordance with an LP-WUS periodicity. The one or more LP-WUS periods of the group of LP-WUS periods may be associated with a respective physical downlink control channel (PDCCH) monitoring window of a group of PDCCH monitoring windows. The method also includes monitoring for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window. The method further includes receiving the PDCCH during the first PDCCH monitoring window in accordance with monitoring for the PDCCH.

### FIELD OF THE DISCLOSURE

The present disclosure relates generally to wireless communication, and more specifically to a low-power wake-up signal (LP-WUS) for low-latency traffic.

### BACKGROUND

Wireless communication systems are widely deployed to provide various telecommunications services such as telephony, video, data, messaging, and broadcasts. Typical wireless communication systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communication network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

In some wireless communication systems, a low-power wake-up signal (LP-WUS) may be used by a receiver, such as a UE, to manage power consumption. The LP-WUS is an example of a wake-up signal. In some examples, the UE may periodically wake up to monitor for the LP-WUS. In response to detecting the LP-WUS, the UE may wake up and remain active to monitor for a physical downlink control channel (PDCCH). This approach allows the UE to manage its power usage by remaining in a low-power state until it is necessary to monitor the PDCCH.

### SUMMARY

In some aspects of the present disclosure, a method for wireless communication at a user equipment (UE) includes monitoring for a low-power wake-up signal (LP-WUS) during one or more LP-WUS periods of a group of LP-WUS periods. The method further includes monitoring for a physical downlink control channel (PDCCH) during a first PDCCH monitoring window of the group of PDCCH monitoring windows in accordance with detecting the LP-WUS during a first LP-WUS period, of the group of LP-WUS periods, corresponding to the first PDCCH monitoring window. The method also includes receiving the PDCCH during the first PDCCH monitoring window in accordance with monitoring for the PDCCH.

Other aspects of the present disclosure are directed to an apparatus. The apparatus includes means for monitoring for an LP-WUS during one or more LP-WUS periods of a group of LP-WUS periods. The apparatus further includes means for monitoring for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window. The apparatus also includes means for receiving the PDCCH during the first PDCCH monitoring window in accordance with monitoring for the PDCCH.

In other aspects of the present disclosure, a non-transitory computer-readable medium with program code recorded thereon is disclosed. The program code is executed by one or more processors and includes program code to monitor for an LP-WUS during one or more LP-WUS periods of a group of LP-WUS periods. The program code further includes program code to monitor for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window. The program code also includes program code to receive the PDCCH during the first PDCCH monitoring window in accordance with monitoring for the PDCCH.

Other aspects of the present disclosure are directed to an apparatus. The apparatus includes one or more memories coupled with the one or more processors and storing processor-executable code that, when executed by the one or more processors, is configured to cause the apparatus to monitor for an LP-WUS during one or more LP-WUS periods of a group of LP-WUS periods. Execution of the instructions also cause the apparatus to monitor for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window. Execution of the instructions further cause the apparatus to receive the PDCCH during the first PDCCH monitoring window in accordance with monitoring for the PDCCH.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3 is a block diagram illustrating an example disaggregated base station architecture, in accordance with various aspects of the present disclosure.

FIG. 4A is a timeline illustrating an example of monitoring based on both a connected-mode discontinuous reception (C-DRX) cycle and one or more physical downlink control channel (PDCCH) monitoring windows outside a C-DRX active time.

FIG. 4B is a timeline illustrating an example of monitoring for the low-power wake-up signal (LP-WUS) based on PDCCH monitoring windows.

FIG. 5 is a timeline illustrating an example of LP-WUS monitoring windows associated with a PDCCH monitoring window having a non-integer periodicity.

FIG. 6 is a timeline illustrating an example of a first PDCCH monitoring window overlapping a second PDCCH monitoring window associated with a C-DRX active window.

FIG. 7 is a timeline illustrating an example of configuring an LP-WUS periodicity based on leap cycles, in accordance with various aspects of the present disclosure.

FIG. 8A is a timeline illustrating an example of LP-WUS periods matching a periodicity of a C-DRX cycle, in accordance with various aspects of the present disclosure.

FIG. 8B is a timeline illustrating an example of LP-WUS periods having a periodicity associated with a leap cycle, in accordance with various aspects of the present disclosure.

FIG. 9A, is a timeline illustrating a network configuration specifying a quantity of LP-WUS periods between two C-DRX active windows and the corresponding offsets.

FIG. 9B is a timeline illustrating an example of determining a set of LP-WUS periods based on an offset relative to a C-DRX active window, in accordance with various aspects of the present disclosure.

FIG. 10 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

As discussed, in some wireless communication systems, a low-power wake-up signal (LP-WUS) may be used by a receiver, such as a user equipment (UE), to manage power consumption. The LP-WUS is an example of a wake-up signal. In some examples, the UE may periodically wake up to monitor for the LP-WUS. In response to detecting the LP-WUS, the UE may wake up and remain active to monitor for a physical downlink control channel (PDCCH). This approach allows the UE to manage its power usage by remaining in a low-power state until it is necessary to monitor the PDCCH.

In some conventional systems, a UE only monitors for downlink control information (DCI) during one or more active periods defined by a connected-mode discontinuous reception (C-DRX) cycle, which can lead to delays in data transmission if the DCI scheduling occurs outside these active periods. In some examples, to reduce the latency of DCI scheduled data transmissions, the UE may monitor for the LP-WUS outside of the C-DRX active time. Although LP-WUS monitoring may extend beyond the C-DRX active time, other measurements, such as radio resource management (RRM) measurements, may continue to follow the conventional C-DRX cycle. Additional opportunities for data scheduling may be created based on the UE monitoring the LP-WUS outside the C-DRX active time.

In some examples, LP-WUS monitoring may occur outside the C-DRX active time in accordance with an LP-WUS monitoring configuration. In some such examples, some LP-WUS periods may be outside the C-DRX active time, while one or more PDCCH monitoring windows may be triggered by the legacy C-DRX cycle and the drx-onDurationTimer. In other examples, PDCCH monitoring may be independent of an on-duration timer, such as a drx-onDurationTimer. In such examples, PDCCH monitoring is not triggered by the legacy C-DRX cycle and drx-onDurationTimer when monitoring for a LP-WUS. Instead, PDCCH monitoring may exclusively follow the LP-WUS monitoring configuration. Accordingly, the UE may either integrate LP-WUS monitoring with the legacy C-DRX mechanisms for additional triggering or operate independently of the legacy C-DRX settings to optimize power consumption and reduce latency.

Various aspects of the present disclosure are directed to determining the location of each LP-WUS period of a set of LP-WUS periods and respective PDCCH monitoring windows associated with each LP-WUS period. In some examples, the respective PDCCH monitoring windows associated with one or more LP-WUS periods of the set of LP-WUS periods may be associated with a C-DRX active time. In other examples, each PDCCH monitoring window is triggered by an LP-WUS of the set of the LP-WUS periods outside of a C-DRX active time. In some examples, an LP-WUS period may be first determined, and then subsequent PDCCH monitoring windows may be identified by adding a time offset to the LP-WUS period. In other examples, the PDCCH monitoring window location may be first identified, and then the preceding LP-WUS monitoring occasion may be identified by subtracting a time offset.

Some applications, such as extended reality (XR) applications, may generate data at non-integer intervals, such as 25/3 ms, 50/3 ms, or 100/3 ms. These non-standard intervals pose a challenge for conventional periodic monitoring and scheduling systems that operate on integer millisecond cycles. In some examples, one or more PDCCH monitoring windows may be associated with non-integer interval data transmissions.

Particular aspects of the subject matter described in this disclosure can be implemented to realize one or more of the following potential advantages. In some examples, the described techniques, such as determining a location of each LP-WUS period and the associated PDCCH monitoring window, may reduce latency and improve power efficiency of the UE.

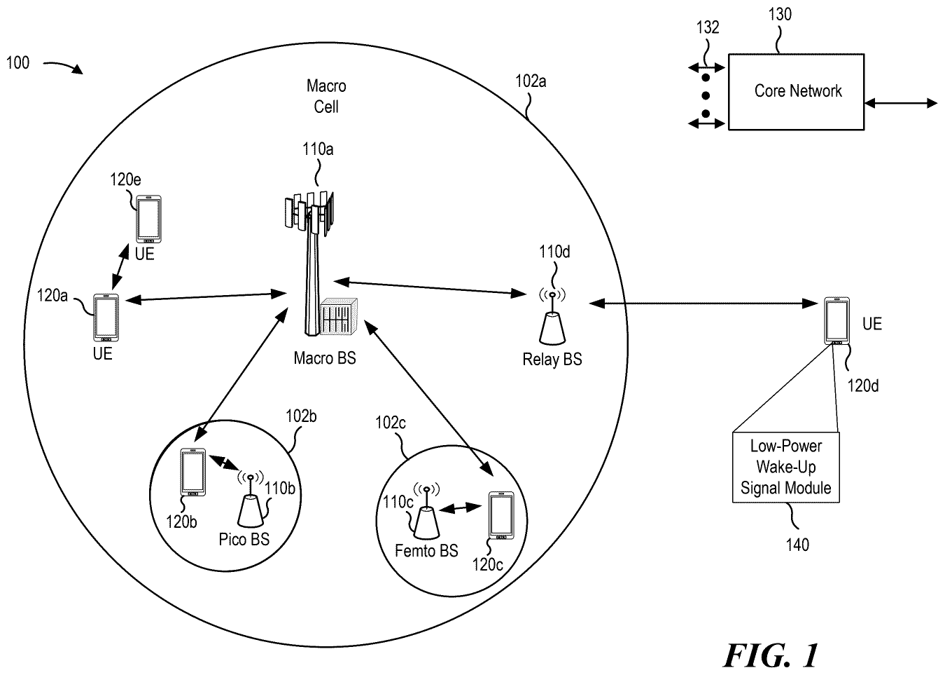

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

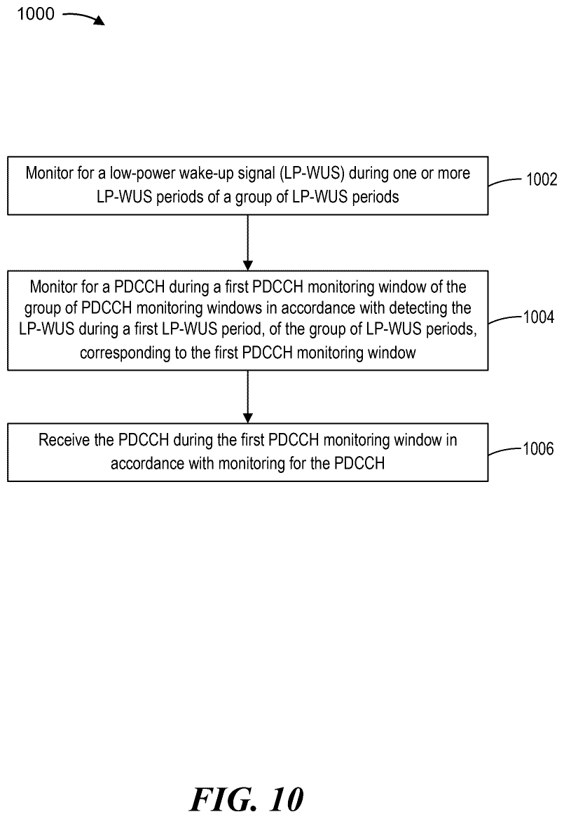

The UEs 120 may include an LP-WUS module 140. For brevity, only one UE 120d is shown as including the LP-WUS module 140. The LP-WUS module 140 may perform one or more operations, such as one or more operations associated with the process 1000 described with reference to FIG. 10.

Some UEs may be considered machine-type communications (MTC) or evolved or enhanced machine-type communications (cMTC) UEs. MTC and cMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

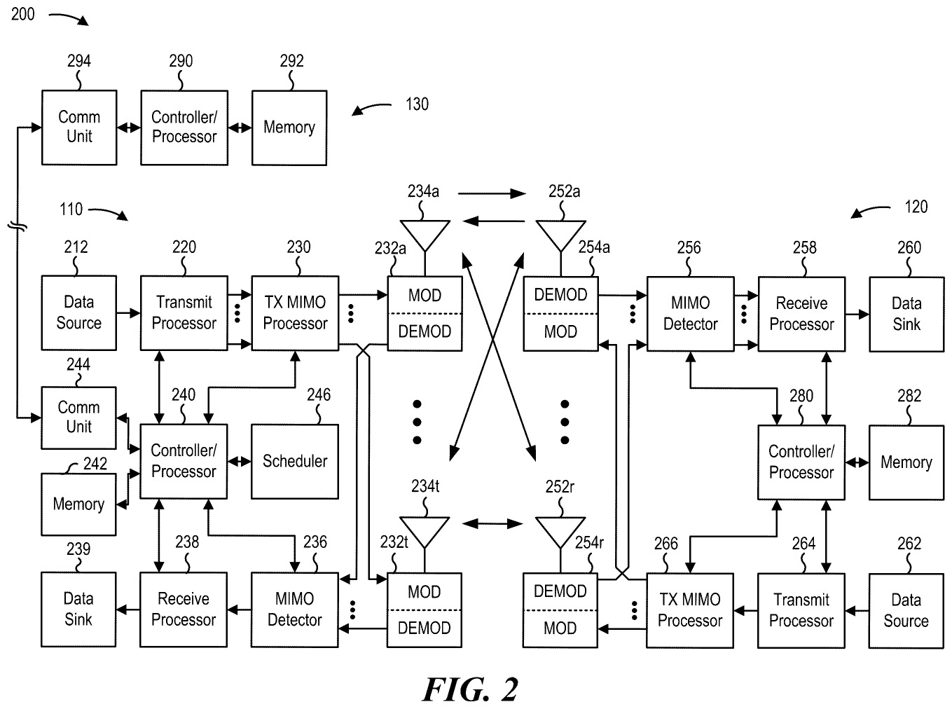

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with determining one or more LP-WUS periods as described in more detail elsewhere. For example, the controller/processor 240 of the base station 110, the controller/processor 280 of the UE 120, and/or any other component(s) of FIG. 2 may perform or direct operations of, for example, the process 1000 of FIG. 10 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for monitoring for a low-power wake-up signal (LP-WUS) during one or more LP-WUS periods of a group of LP-WUS periods, the one or more LP-WUS periods configured in accordance with an LP-WUS periodicity, the one or more LP-WUS periods of the group of LP-WUS periods associated with a respective physical downlink control channel (PDCCH) monitoring window of a group of PDCCH monitoring windows; means for monitoring for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window; and means for receiving the PDCCH during the first PDCCH monitoring window in accordance with monitoring for the PDCCH. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (cNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (cMBB) applications, vehicle-to-anything (V2X) applications, and/or the like. Furthermore, in some cases, a single device may support different applications or services simultaneously.

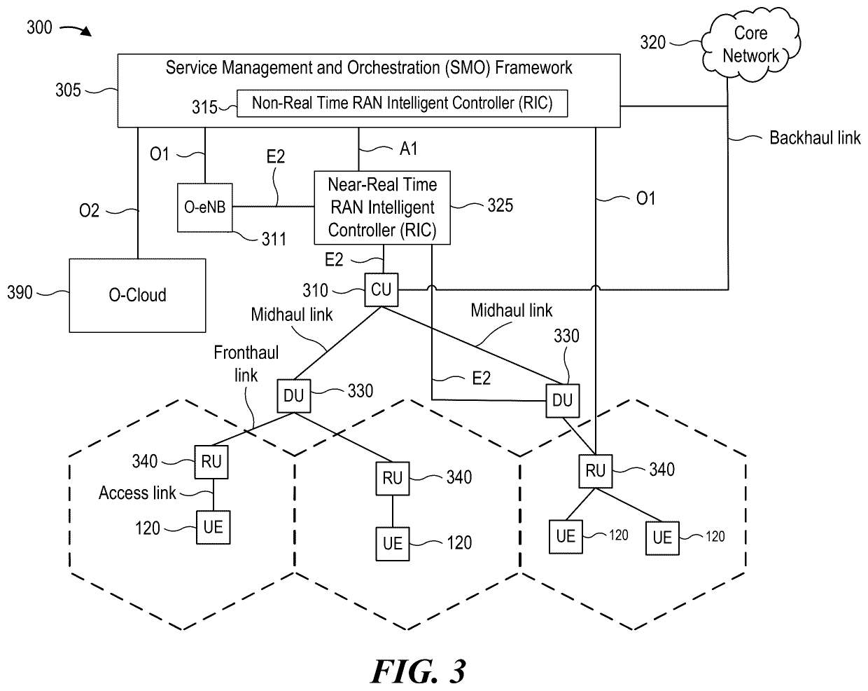

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-cNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-CNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

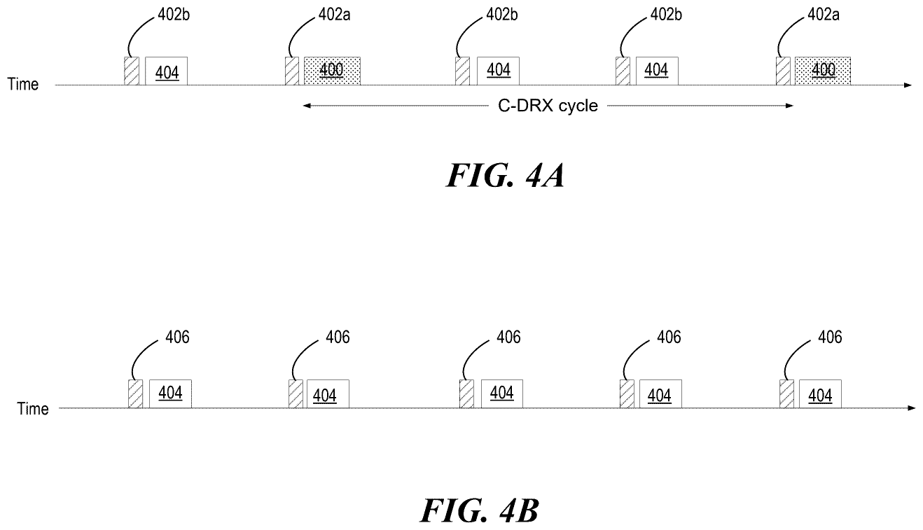

As discussed, in some examples, LP-WUS monitoring may occur outside the C-DRX active time in accordance with an LP-WUS monitoring configuration. In some such examples, PDCCH monitoring may be independent of an on-duration timer, such as a drx-onDurationTimer. Specifically, in some cases, PDCCH monitoring may be additionally triggered by the C-DRX cycle and the drx-onDurationTimer while monitoring LP-WUS. FIG. 4A is a timeline illustrating an example of monitoring based on both a C-DRX cycle and PDCCH monitoring windows outside a C-DRX active time. In the example of FIG. 4A, a C-DRX active time 400 is scheduled in accordance with the C-DRX cycle. As shown in FIG. 4A, each C-DRX active time 400 is associated with a respective LP-WUS monitoring occasion 402a, 402b. The C-DRX active time 400 may also be referred to as a C-DRX on-duration period (used interchangeably). In some examples, if a UE receives the LP-WUS at an LP-WUS monitoring occasion 402a before a start of one of the C-DRX active times 400, the UE may remain active during a period associated with the respective C-DRX active time 400 to monitor for a physical downlink control channel (PDCCH). If the LP-WUS is not received before the start of one of the C-DRX active times 400, the UE skips a period associated with the respective C-DRX active time 400. The C-DRX active time 400 may be extended if an inactivity timer is triggered by PDCCH messages received by the UE. In this example, the C-DRX active time 400, which includes the on-duration and any extensions, will be longer than the initial on-duration.

Conversely, if the UE receives the LP-WUS during an LP-WUS monitoring occasion 402b that is not associated with a C-DRX active time 400, but before a scheduled PDCCH monitoring window 404, the UE may remain active to monitor for the PDCCH during the respective PDCCH monitoring window 404. If the LP-WUS is not received in this timeframe, the UE skips the PDCCH monitoring window 404. The initial duration of the PDCCH monitoring window 404 may be configured by a network node, similar to the C-DRX active time 400.

In some examples, PDCCH monitoring is not triggered by the C-DRX cycle and/or the drx-onDurationTimer when monitoring the LP-WUS. Instead, PDCCH monitoring may exclusively follow the LP-WUS monitoring configuration. That is, a UE's monitoring activities may be solely governed by the LP-WUS schedule without relying on C-DRX active times. FIG. 4B is a timeline illustrating an example of monitoring for the LP-WUS based on PDCCH monitoring windows. In the example of FIG. 4B, each LP-WUS monitoring occasion 406 is associated with a scheduled PDCCH monitoring window 404. In such examples, if the UE receives the LP-WUS during an LP-WUS monitoring occasion 406 before a scheduled PDCCH monitoring window 404, the UE may remain active to monitor for the PDCCH during the respective PDCCH monitoring window 404. If the LP-WUS is not received in this timeframe, the UE skips the PDCCH monitoring window 404.

In accordance with various aspects of the present disclosure, a network node may configure specific periods for LP-WUS transmissions. Within each of these periods, one or more LP-WUS monitoring occasions (MOs) may be configured for each of the LP-WUS transmission periods. The one or more LP-WUS monitoring occasions may account for repetitions of the LP-WUS. For duty-cycled LP-WUS transmissions, the LP-WUS monitoring occasions may not occupy the entire LP-WUS period. The location of an LP-WUS period may be determined either based on a start of the first LP-WUS monitoring occasion in the LP-WUS transmission period or the end of the last LP-WUS monitoring occasion within the LP-WUS transmission period.

Various aspects of the present disclosure are directed to determining a location of each LP-WUS period and the associated PDCCH monitoring window. In some examples, the LP-WUS period location may be determined first, and then a subsequent PDCCH monitoring window may be determined by adding a time offset to the LP-WUS period location. In some other examples, the PDCCH monitoring window location may be determined first, and then a preceding LP-WUS monitoring occasion may be determined by subtracting a time offset from the PDCCH monitoring window location.

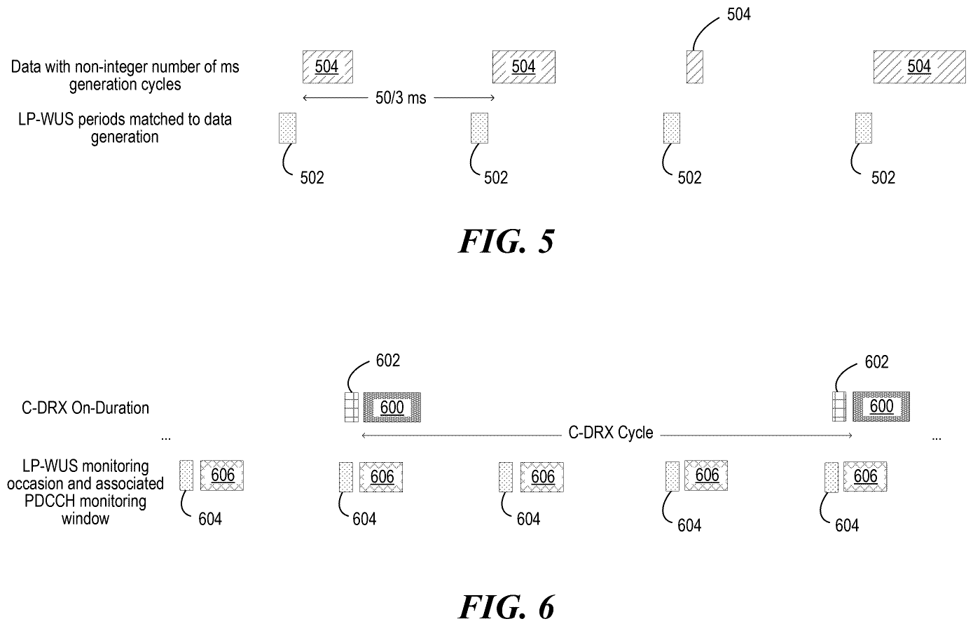

In some examples, a traffic model may include transmissions that are associated with non-integer cycles, such as transmissions that are transmitted at 25/3, 50/3, or 100/3 ms cycles, for example. Such transmissions may be associated with extended reality (XR) devices or other devices. Additionally, such transmissions may be latency-sensitive. FIG. 5 is a timeline illustrating an example of LP-WUS monitoring windows associated PDCCH monitoring window having a non-integer periodicity. As shown in the example of FIG. 5, each LP-WUS monitoring window 502 may be associated with a PDCCH monitoring window 504. A duration of each PDCCH monitoring window 504 may vary. Furthermore, a periodicity of the PDCCH monitoring window 504 may be a non-integer periodicity. For example, in the example of FIG. 5, a period between adjacent PDCCH monitoring windows 504 is 50/3 ms.

In some examples, a first PDCCH monitoring window may overlap with a C-DRX active window (e.g., second PDCCH monitoring window) based on the first PDCCH monitoring window and the C-DRX active window being unsynchronized. FIG. 6 is a timeline illustrating an example of a first PDCCH monitoring window overlapping a second PDCCH monitoring window associated with a C-DRX active window. The C-DRX active window may also be referred to as a C-DRX on-duration. As shown in the example of FIG. 6, C-DRX active windows 600 may be scheduled in accordance with a C-DRX cycle. Each C-DRX active window 600 represents an active monitoring period within each C-DRX cycle where the UE may actively listen (e.g., monitor) for data transmissions. An LP-WUS period 602 may be associated with each C-DRX active window 600. The LP-WUS period 602 may also be referred to as an LP-WUS monitoring window or an LP-WUS monitoring occasion.

Additionally, as shown in FIG. 6, LP-WUS periods 604 may be associated with PDCCH monitoring periods 606 that are independent of a C-DRX cycle. As shown in the example of FIG. 6, in some cases, a C-DRX active window 600 may overlap with a PDCCH monitoring period 606. Various aspects of the present disclosure are directed to handling situations where the C-DRX active window 600 overlaps with the PDCCH monitoring period 606.

In some examples, PDCCH monitoring periods may be aligned with non-integer data cycles, such as the non-integer data cycles associated with XR transmissions. In such examples, the periodicity of LP-WUS periods may be a non-integer number of milliseconds (ms) or uneven in time. For example, the periodicity of the LP-WUS periods may match the XR data cycle, which may be 25/3 ms, 50/3 ms, or 100/3 ms. Additionally, a smaller periodicity, such as 25/6 ms, may be specified to accommodate other types of traffic, such as sensor data with 4 ms cycles.

In some examples, non-integer periodicities may be quantized into a finite granularity timeline of a UE. In some such examples, a location of each LP-WUS period may be quantized to a nearest millisecond or slot boundary. For example, an LP-WUS period may be configured at

$$\frac{25}{6} * n + m$$

ms, where n represents an LP-WUS period index and m is a time offset. In this example, an actual location for each LP-WUS period may be rounded to the nearest millisecond boundary or a boundary of

$$\frac{1}{{2}^{μ}}$$

ms, where μ=0, 1, 2, 3 . . . , represents a subcarrier spacing factor.

In some other examples, leap cycles may be used to determine a respective location of each LP-WUS period. For example, a 25/3 ms periodicity may be configured, by a network node, for the LP-WUS. In this example, three LP-WUS periods within every 25 ms can be specified in accordance with offsets of {8, 8, 9} ms from each preceding LP-WUS period. For example, if the first LP-WUS period is at n ms, the subsequent periods would be at n+8 ms, n+16 ms, and n+25 ms, respectively, in accordance with the leap cycle periodicity, where n is an integer value.

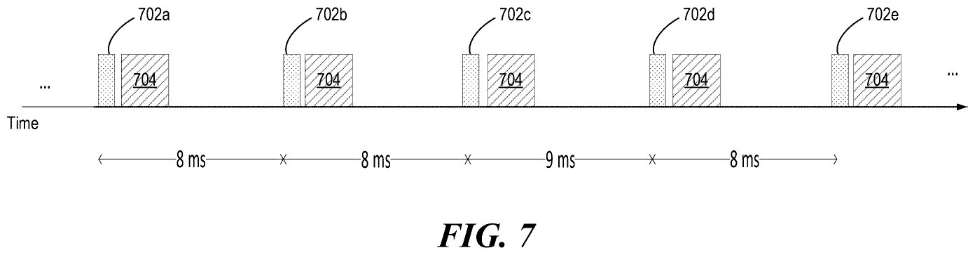

FIG. 7 is a timeline illustrating an example of configuring an LP-WUS periodicity based on leap cycles, in accordance with various aspects of the present disclosure. In the example of FIG. 7, a 25/3 ms periodicity may be configured, by a network node, for the LP-WUS periods. Based on the 25/3 ms periodicity, three LP-WUS periods 702 may be specified within a 25 ms period with an offset of {8, 8, 9} ms between a sequence of LP-WUS periods 702. Each offset may be based on a preceding LP-WUS period 702. Thus, as shown in the example of FIG. 7, an offset between a first LP-WUS period 702a and a second LP-WUS period 702b may be 8 ms, an offset between the second LP-WUS period 702b and a third LP-WUS period 702c may be 8 ms, an offset between the third LP-WUS period 702c and a fourth LP-WUS period 702d may be 9 ms. The offsets of {8, 8, 9} ms may repeat for subsequent LP-WUS periods 702. Each LP-WUS period may be associated with a PDCCH monitoring window 704. Aspects of the present disclosure are not limited to a 25 ms period with an offset of {8, 8, 9} ms between adjacent LP-WUS periods 702. The period and offset (e.g., leap cycle) may be a function of the periodicity configured by the network node. Aspects of the present disclosure may also use the leap cycle to determine the LP-WUS periods 702 when one or more LP-WUS periods are associated with a C-DRX on-duration.

In accordance with various aspects, the quantization of the LP-WUS periodicity may be based on either first determining the LP-WUS period locations and then determining the PDCCH monitoring window locations, or first determining the PDCCH monitoring window locations and then determining respective LP-WUS monitoring occasions.

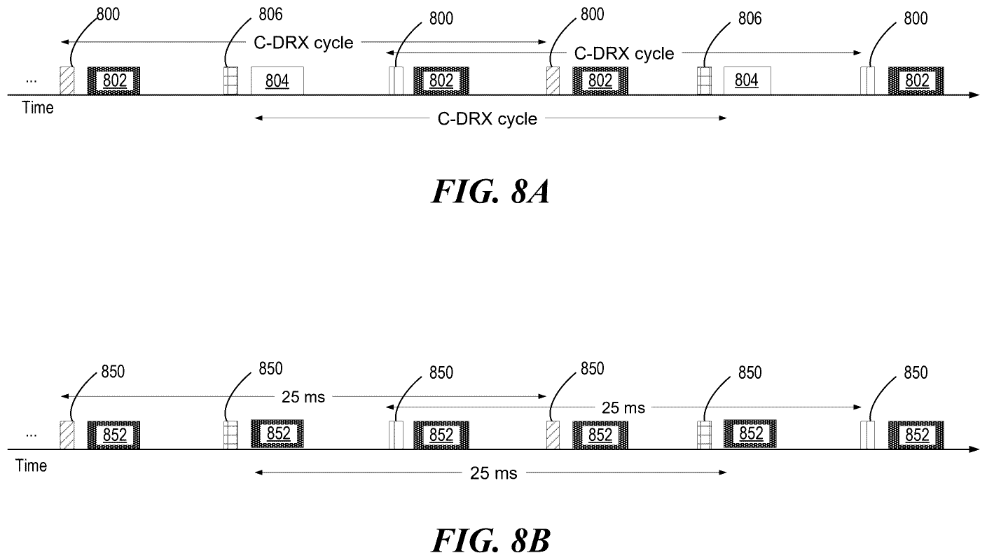

In some examples, multiple LP-WUS periods may be configured with a same periodicity but with different start offsets. In some examples, the periodicity for LP-WUS periods may match a periodicity of a C-DRX cycle, but each LP-WUS period may have a different start offset than a start offset of each C-DRX active window. FIG. 8A is a timeline illustrating an example of LP-WUS periods 800 matching a periodicity of a C-DRX cycle, in accordance with various aspects of the present disclosure. In the example of FIG. 8A, each LP-WUS period 800 of a first set of LP-WUS periods is associated with a PDCCH monitoring window 802 that is different than a C-DRX active time 804. Additionally, each C-DRX active time 804 is associated with a respective LP-WUS period 806 of a second set of LP-WUS periods. As shown in the example of FIG. 8A, each C-DRX cycle has a different starting offset. That is, a C-DRX cycle associated with each LP-WUS period 800 of a first set of LP-WUS periods has a different starting offset than a C-DRX cycle associated with the C-DRX active time 804. In the example of FIG. 8A, corresponding LP-WUS periods 800 and 806 may have a same hatching pattern. Each of the corresponding LP-WUS periods 800 and 806 may be associated with a respective LP-WUS configuration.

In some examples, the aspects described with reference to FIG. 8A may be used to first generate the PDCCH monitoring windows 802, and the locations of the associated LP-WUS periods 800 may be determined based on the PDCCH monitoring windows 802. In such an example, based on the example of FIG. 8A, only two sets of PDCCH monitoring windows 802 may need to be configured. Each set of PDCCH monitoring windows 802 may be associated with a different LP-WUS period 800 (identified by different hatching patterns in FIG. 8A). Additionally, the C-DRX active times 804 may be used to determine the associated LP-WUS periods 806.

In some other examples, each LP-WUS period may be associated with a PDCCH monitoring window. In such examples, LP-WUS periods are not associated with a C-DRX active time. In some such examples, the periodicity of the LP-WUS periods may be set to a leap cycle, each leap cycle being associated with a different starting offset. FIG. 8B is a timeline illustrating an example of LP-WUS periods 850 having a periodicity associated with a leap cycle, in accordance with various aspects of the present disclosure. As shown in the example of FIG. 8B, the periodicity of the LP-WUS periods 850 is set to the leap cycle. In this example, the leap cycle is 25 (ms) for a 25/3 ms LP-WUS periodicity. Each leap cycle has a different start offset. In the example of FIG. 8B, instead of setting LP-WUS periods 850 at non-integer intervals, the leap cycle configures multiple LP-WUS periods 850 within a 25 ms cycle. This allows the network to preserve integer boundaries for each LP-WUS period 850, simplifying synchronization and implementation. The periodicity remains consistent at 25 ms, such that each LP-WUS period 850 is an integer number of milliseconds (ms), despite the underlying non-integer periodicity of 25/3 ms. In the example of FIG. 8B, each LP-WUS period 850 is associated with a PDCCH monitoring window 852. In the example of FIG. 8B, corresponding LP-WUS periods 850 may have a same hatching pattern. Each of the corresponding LP-WUS periods 850 may be associated with a respective LP-WUS configuration. In some examples, the aspects described with reference to FIG. 8B may be used to first generate PDCCH monitoring windows 852, and the locations of the associated LP-WUS periods 850 may be determined based on the PDCCH monitoring windows 852.

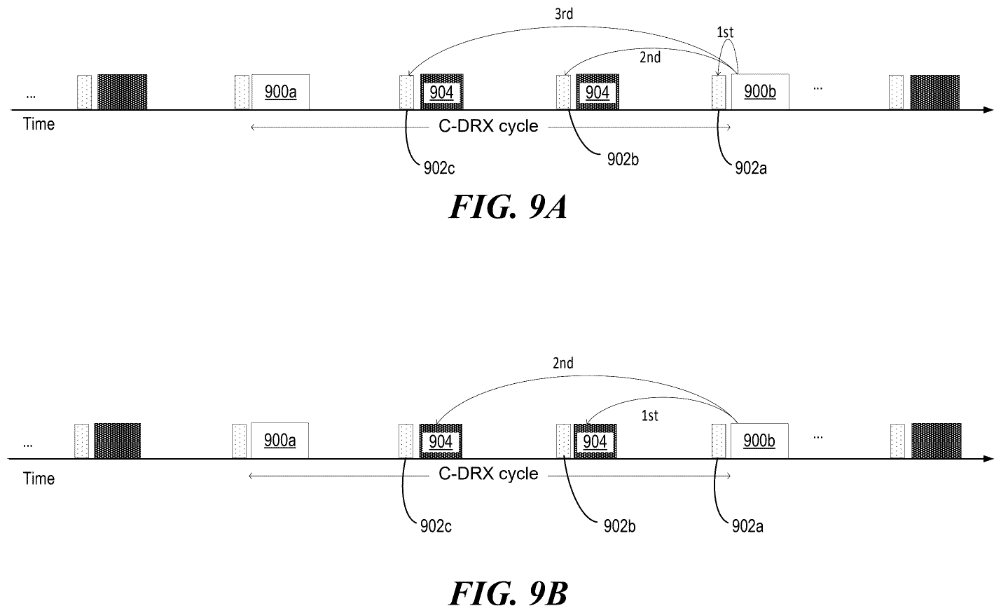

In some examples, a location of one or more LP-WUS periods may be determined based on an offset relative to a C-DRX active window. FIG. 9A is a timeline illustrating an example of determining a set of LP-WUS periods based on an offset relative to a C-DRX active window, in accordance with various aspects of the present disclosure. In the example of FIG. 9A, a network configuration specifies a quantity of LP-WUS periods between two C-DRX active windows 900a and 900b and the corresponding offsets. In the example of FIG. 9A, the network configuration specifies three LP-WUS periods 902a, 902b, and 902c between the two C-DRX active windows 900a and 900b. A first offset associated with a first LP-WUS period 902a indicates an LP-WUS period associated with the second C-DRX active window 900b. The other two LP-WUS periods 902b and 902c may be associated with PDCCH monitoring windows 904. Based on the network configuration, the LP-WUS periods 902a, 902b, and 902c may be accurately positioned in relation to the C-DRX active window 900b, providing a structured schedule for monitoring LP-WUSs.

FIG. 9B is a timeline illustrating an example of determining a set of LP-WUS periods 902 based on an offset relative to a C-DRX active window 900b, in accordance with various aspects of the present disclosure. In the example of FIG. 9B, based on the network configuration, the UE first determines the PDCCH monitoring windows 904 between the two C-DRX active windows 900a and 900b, and then the UE identifies the associated LP-WUS periods 902a, 902b, and 902c. In the example of FIG. 9B, the network node may only configure two offsets, each offset corresponding to a respective PDCCH monitoring window 904 between the two C-DRX active windows 900a and 900b. Additionally, to determine the LP-WUS periods 902a, 902b, and 902c, the network node may configure an offset to each PDCCH monitoring window 904 and/or the C-DRX active window 900b.

As discussed, in some examples, a PDCCH monitoring window may collide (e.g., overlap) with a C-DRX active window (e.g., C-DRX on-duration). This issue arises when LP-WUS periods are determined for both C-DRX active windows and PDCCH monitoring windows that occur outside of the C-DRX active time. For example, when PDCCH monitoring windows are periodically configured (for example, based on quantizing a non-integer periodicity or with an integer periodicity), one or more of the PDCCH monitoring windows may overlap with a C-DRX active window. In some other examples, one or more PDCCH monitoring windows may overlap a C-DRX active window where the number of configured PDCCH monitoring windows between two C-DRX active windows exceeds the available space (e.g., an available quantity of symbols) between the two C-DRX active windows.

Collisions may occur during one or more periods in accordance with one or more scenarios. In a first scenario, the collision may occur at an LP-WUS period. This LP-WUS period may occur before a C-DRX active window or a PDCCH monitoring window. In a second scenario, the collision may occur at a period associated with a C-DRX active window or a configured PDCCH monitoring window. This period refers to an actual time during which the UE is actively monitoring for the PDCCH. In a third scenario, the collision may occur at a period that includes both the LP-WUS period and a corresponding C-DRX active window or a corresponding PDCCH monitoring window. In a fourth scenario, the collision may occur at the LP-WUS period, a corresponding C-DRX active window or PDCCH monitoring window, or an extended period for PDCCH monitoring. The extended period may be enabled in accordance with the UE receiving the PDCCH during the C-DRX on-duration or the configured PDCCH monitoring window, thereby extending the monitoring period. In a fifth scenario, the collision may occur at any period described with respect to the third or fourth scenario, in addition to an additional PDCCH monitoring period that is scheduled in accordance with the network node scheduling one or more retransmissions.

Based on the discussed scenarios, there are twenty-five possible combinations of collisions between the PDCCH monitoring windows and C-DRX active periods. These collisions can occur due to the overlapping timing of PDCCH monitoring windows and C-DRX active windows. The first, second, and third scenarios described above are associated with semi-statically configured time periods, meaning the timing of the discussed periods are predetermined and relatively fixed. Consequently, any collisions involving these periods may be managed semi-statically. In some examples, the UE may be configured to account for potential overlaps and ensure proper synchronization. Additionally, the fourth and fifth scenarios described above may be dynamically determined based on real-time events, such as receiving a PDCCH signal or scheduling one or more retransmissions. Because these periods are not fixed and can change based on network conditions and UE activity, collisions involving these periods must be handled dynamically. In such examples, the UE may adapt in real time to manage overlaps without significant performance degradation.

In some examples, various solutions may be specified when a first period (e.g., duration) of a PDCCH monitoring window associated with one or more of the first through fifth scenarios described above overlaps with a second period (e.g., duration) associated with the C-DRX active window associated with one or more of the first through fifth scenarios. In some examples, the first period may be kept, and the second period may be skipped. In such examples, the UE prioritizes the PDCCH monitoring window over the C-DRX active window. Consequently, the LP-WUS for the second period may also be skipped, such that the monitoring focus remains on the first period.

In other examples, the first period may be skipped, and the second period may be kept. Here, the UE prioritizes the C-DRX active window over the PDCCH monitoring window. As a result, the LP-WUS for the first duration may also be skipped, allowing the UE to maintain its scheduled C-DRX activities. This solution may be limited to the first, second, or third scenario because the periods associated with these scenarios are semi-statically configured and can be determined before the first period. In other examples, the UE may maintain a union between the first and second periods. This approach merges both periods so that monitoring covers the entire overlapping period. The LP-WUS for the second period may still be skipped to avoid redundant monitoring and conserve power.

FIG. 10 is a flow diagram illustrating an example process 1000 performed, for example, by a user equipment (UE), in accordance with various aspects of the present disclosure. The example process 1000 is an example of determining the location of each LP-WUS period of a set of LP-WUS periods and respective PDCCH monitoring windows associated with each LP-WUS period. The process 1000 begins at block 1002 by monitoring for a low-power wake-up signal (LP-WUS) during one or more LP-WUS periods of a group of LP-WUS periods. The one or more LP-WUS periods may be configured in accordance with an LP-WUS periodicity. The one or more LP-WUS periods of the group of LP-WUS periods may be associated with a respective physical downlink control channel (PDCCH) monitoring window of a group of PDCCH monitoring windows. At block 1004, the process 1000 monitors for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window. At block 1006, the process 1000 receives the PDCCH during the first PDCCH monitoring window in accordance with monitoring for the PDCCH.

Implementation examples are described in the following numbered clauses:
Clause 1. A method for wireless communication at a user equipment (UE), comprising: monitoring for a low-power wake-up signal (LP-WUS) during one or more LP-WUS periods of a group of LP-WUS periods, the one or more LP-WUS periods configured in accordance with an LP-WUS periodicity, the one or more LP-WUS periods of the group of LP-WUS periods associated with a respective physical downlink control channel (PDCCH) monitoring window of a group of PDCCH monitoring windows; monitoring for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window; and receiving the PDCCH during the first PDCCH monitoring window in accordance with monitoring for the PDCCH.
Clause 2. The method of Clause 1, wherein: the group of PDCCH monitoring windows includes a first set of PDCCH monitoring windows and a second set of PDCCH monitoring windows; one or more PDCCH monitoring windows of the first set of PDCCH monitoring windows are associated with a respective connected-mode discontinuous reception (C-DRX) active window of a group of C-DRX active windows; and further comprising monitoring for the PDCCH during one or more PDCCH monitoring windows of the first set of PDCCH monitoring windows in accordance with a C-DRX cycle and a discontinuous reception (drx) on-duration timer.
Clause 3. The method of Clause 2, further comprising: receiving, from a network node, a message indicating a quantity of LP-WUS periods between a pair of C-DRX active windows and a corresponding quantity of offsets; and determining one or more LP-WUS periods of the group of LP-WUS periods based on the corresponding quantity of offsets in relation to a location of one C-DRX active window of the pair of C-DRX active windows.
Clause 4. The method of Clause 2, wherein: a first duration associated with one of the second set of PDCCH monitoring windows overlaps a second duration associated with a C-DRX active window of the group of C-DRX active windows; the first duration and/or the second duration include one or more of a corresponding LP-WUS period, a PDCCH monitoring window period, a C-DRX active window period, an extended PDCCH monitoring period, or an additional PDCCH monitoring period associated with a retransmission; and the UE mitigates the overlap by: maintaining the first duration and skipping the second duration; maintaining the second duration and skipping the first duration; or maintaining a union of the first duration and the second duration.
Clause 5. The method of any one of Clauses 1-4, wherein the PDCCH is monitored at one or more PDCCH monitoring windows of the group of PDCCH monitoring windows irrespective of a connected-mode discontinuous reception (C-DRX) cycle and a discontinuous reception (drx) on-duration.
Clause 6. The method of any one of Clauses 1-5, wherein a location of the one or more LP-WUS periods of the group of LP-WUS periods are quantized to an integer based periodicity or a slot boundary in accordance with the LP-WUS periodicity being a non-integer based periodicity.
Clause 7. The method of any one of Clauses 1-5, wherein a location of the one or more LP-WUS periods of the group of LP-WUS periods are based on an integer based offset from a preceding LP-WUS period in accordance with the LP-WUS periodicity being a non-integer based periodicity.
Clause 8. The method of any one of Clauses 1-7, wherein: each LP-WUS period of the group of LP-WUS periods is associated with one periodicity of a group of periodicities; and each one of the group of periodicities has a different starting offset.
Clause 9. The method of Clause 8, wherein each periodicity of the group of periodicities is associated with a connected-mode discontinuous reception (C-DRX) cycle.
Clause 10. The method of Clause 8, wherein each periodicity of the group of periodicities is associated with an LP-WUS leap cycle.
Clause 11. The method of any one of Clauses 1-10, wherein: each PDCCH monitoring window of the group of PDCCH monitoring windows is associated with one periodicity of a group of periodicities; and further comprising determining a first location of each LP-WUS period based on a second location of a corresponding PDCCH monitoring window of the group of PDCCH monitoring windows.
Clause 12. The method of Clause 10, wherein each periodicity of the group of periodicities is associated with a connected-mode discontinuous reception (C-DRX) cycle.
Clause 13. The method of any one of Clauses 1-12, further comprising: determining a location of one or more PDCCH monitoring windows of the group of PDCCH monitoring windows; and determining a respective location of the one or more LP-WUS periods based on the location of the PDCCH monitoring window corresponding to a respective LP-WUS period of the one or more LP-WUS periods.
Clause 14. An apparatus comprising one or more processors, one or more memories coupled with the one or more processors, and instructions stored in the memory and operable, when executed by the one or more processors to cause the apparatus to perform any one of Clauses 1-13.
Clause 15. An apparatus comprising at least one means for performing any one of Clauses 1-13.
Clause 16. A computer program comprising code for causing an apparatus to perform any one of Clauses 1-13.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for wireless communication at a user equipment (UE), comprising:
one or more processors; and
one or more memories coupled with the one or more processors and storing processor-executable code that, when executed by the one or more processors, is configured to cause the UE to:
monitor for a low-power wake-up signal (LP-WUS) during one or more LP-WUS periods of a group of LP-WUS periods, the one or more LP-WUS periods configured in accordance with an LP-WUS periodicity, the one or more LP-WUS periods of the group of LP-WUS periods associated with a respective physical downlink control channel (PDCCH) monitoring window of a group of PDCCH monitoring windows;
monitor for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window; and
receive the PDCCH during the first PDCCH monitoring window in accordance with monitoring for the PDCCH.

2. The apparatus of claim 1, wherein:
the group of PDCCH monitoring windows includes a first set of PDCCH monitoring windows and a second set of PDCCH monitoring windows;
one or more PDCCH monitoring windows of the first set of PDCCH monitoring windows are associated with a respective connected-mode discontinuous reception (C-DRX) active window of a group of C-DRX active windows; and
wherein execution of the processor-executable code further causes the UE to monitor for the PDCCH during one or more PDCCH monitoring windows of the first set of PDCCH monitoring windows in accordance with a C-DRX cycle and a discontinuous reception (drx) on-duration timer.

3. The apparatus of claim 2, wherein execution of the processor-executable code further causes the UE to:
receive, from a network node, a message indicating a quantity of LP-WUS periods between a pair of C-DRX active windows and a corresponding quantity of offsets; and
determine one or more LP-WUS periods of the group of LP-WUS periods based on the corresponding quantity of offsets in relation to a location of one C-DRX active window of the pair of C-DRX active windows.

4. The apparatus of claim 2, wherein:
a first duration associated with one of the second set of PDCCH monitoring windows overlaps a second duration associated with a C-DRX active window of the group of C-DRX active windows;
the first duration and/or the second duration include one or more of a corresponding LP-WUS period, a PDCCH monitoring window period, a C-DRX active window period, an extended PDCCH monitoring period, or an additional PDCCH monitoring period associated with a retransmission; and
execution of the processor-executable code further causes the UE to mitigate the overlap by:
maintaining the first duration and skipping the second duration;
maintaining the second duration and skipping the first duration; or
maintaining a union of the first duration and the second duration.

5. The apparatus of claim 1, wherein the PDCCH is monitored at one or more PDCCH monitoring windows of the group of PDCCH monitoring windows irrespective of a connected-mode discontinuous reception (C-DRX) cycle and a discontinuous reception (drx) on-duration.

6. The apparatus of claim 1, wherein a location of the one or more LP-WUS periods of the group of LP-WUS periods are quantized to an integer based periodicity or a slot boundary in accordance with the LP-WUS periodicity being a non-integer based periodicity.

7. The apparatus of claim 1, wherein a location of the one or more LP-WUS periods of the group of LP-WUS periods are based on an integer based offset from a preceding LP-WUS period in accordance with the LP-WUS periodicity being a non-integer based periodicity.

8. The apparatus of claim 1, wherein:
each LP-WUS period of the group of LP-WUS periods is associated with one periodicity of a group of periodicities; and
each one of the group of periodicities has a different starting offset.

9. The apparatus of claim 8, wherein each periodicity of the group of periodicities is associated with a connected-mode discontinuous reception (C-DRX) cycle.

10. The apparatus of claim 8, wherein each periodicity of the group of periodicities is associated with an LP-WUS leap cycle.

11. The apparatus of claim 1, wherein:
each PDCCH monitoring window of the group of PDCCH monitoring windows is associated with one periodicity of a group of periodicities; and
wherein execution of the processor-executable code further causes the UE to determine a first location of each LP-WUS period based on a second location of a corresponding PDCCH monitoring window of the group of PDCCH monitoring windows.

12. The apparatus of claim 10, wherein each periodicity of the group of periodicities is associated with a connected-mode discontinuous reception (C-DRX) cycle.

13. The apparatus of claim 1, wherein execution of the processor-executable code further causes the UE to:
determine a location of one or more PDCCH monitoring windows of the group of PDCCH monitoring windows; and
determine a respective location of the one or more LP-WUS periods based on the location of the PDCCH monitoring window corresponding to a respective LP-WUS period of the one or more LP-WUS periods.

14. A method for wireless communication at a user equipment (UE), comprising:
monitoring for a low-power wake-up signal (LP-WUS) during one or more LP-WUS periods of a group of LP-WUS periods, the one or more LP-WUS periods configured in accordance with an LP-WUS periodicity, the one or more LP-WUS periods of the group of LP-WUS periods associated with a respective physical downlink control channel (PDCCH) monitoring window of a group of PDCCH monitoring windows;
monitoring for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window; and
receiving the PDCCH during the first PDCCH monitoring window in accordance with monitoring for the PDCCH.

15. The method of claim 14, wherein:
the group of PDCCH monitoring windows includes a first set of PDCCH monitoring windows and a second set of PDCCH monitoring windows;
one or more PDCCH monitoring windows of the first set of PDCCH monitoring windows are associated with a respective connected-mode discontinuous reception (C-DRX) active window of a group of C-DRX active windows; and
wherein execution of the processor-executable code further causes the UE to monitor for the PDCCH during one or more PDCCH monitoring windows of the first set of PDCCH monitoring windows in accordance with a C-DRX cycle and a discontinuous reception (drx) on-duration timer.

16. The method of claim 15, further comprising:
receiving, from a network node, a message indicating a quantity of LP-WUS periods between a pair of C-DRX active windows and a corresponding quantity of offsets; and
determining one or more LP-WUS periods of the group of LP-WUS periods based on the corresponding quantity of offsets in relation to a location of one C-DRX active window of the pair of C-DRX active windows.

17. The method of claim 15, wherein:
a first duration associated with one of the second set of PDCCH monitoring windows overlaps a second duration associated with a C-DRX active window of the group of C-DRX active windows;
the first duration and/or the second duration include one or more of a corresponding LP-WUS period, a PDCCH monitoring window period, a C-DRX active window period, an extended PDCCH monitoring period, or an additional PDCCH monitoring period associated with a retransmission; and
the UE mitigates the overlap by:
maintaining the first duration and skipping the second duration;
maintaining the second duration and skipping the first duration; or
maintaining a union of the first duration and the second duration.

18. The method of claim 14, further comprising:
determining a location of one or more PDCCH monitoring windows of the group of PDCCH monitoring windows; and
determining a respective location of the one or more LP-WUS periods based on the location of the PDCCH monitoring window corresponding to a respective LP-WUS period of the one or more LP-WUS periods.

19. The method of claim 14, wherein:
each LP-WUS period of the group of LP-WUS periods is associated with one periodicity of a group of periodicities; and
each one of the group of periodicities has a different starting offset.

20. A non-transitory computer-readable medium having program code recorded thereon for wireless communication by a user equipment (UE), the program code executed by one or more processors and comprising:
program code to monitor for a low-power wake-up signal (LP-WUS) during one or more LP-WUS periods of a group of LP-WUS periods, the one or more LP-WUS periods configured in accordance with an LP-WUS periodicity, the one or more LP-WUS periods of the group of LP-WUS periods associated with a respective physical downlink control channel (PDCCH) monitoring window of a group of PDCCH monitoring windows;
program code to monitor for a PDCCH during a first PDCCH monitoring window of the group of PDCCH monitoring windows in accordance with detecting the LP-WUS during a first LP-WUS period, of the group of LP-WUS periods, corresponding to the first PDCCH monitoring window; and
program code to receive the PDCCH during the first PDCCH monitoring window in accordance with monitoring for the PDCCH.
